(19) United States
(12) Patent Application Publication
(10) Pub. No.: US 2002/0178030 A1
(43) Pub. Date: Nov. 28, 2002

(54) Method and system for promotion of non-invasive and less invasive medical procedures on the internet and by other means

(76) Inventor: Marvin P. Loeb, Huntington Beach, CA (US)

Correspondence Address: IP Focus Law Group, Ltd., 608 North Carlyle, Suite 100, Arlington Heights, IL, 60004, US

(21) Appl. No.: 09/815,793

(22) Filed: Mar. 23, 2001

(51) Int. Cl. G06F 17/60

(52) U.S. Cl. 705/2

(57) ABSTRACT

A computerized method effectively promotes the sale and distribution of medical devices utilized in device-dependent medical or surgical procedures. The method includes maintaining a computerized data directory of a plurality of procedure-qualified medical service providers, providing a user interface to the data directory through a wide access communication network such as the Internet or the public telephone system, receiving an inquiry pertaining to a medical condition of concern to the user, providing information to the user on treatment options for the medical condition of concern, including information on the device dependent medical or surgical procedure, and querying the data directory to find a procedure-qualified medical service provider available to the user. The results of the query are communicated to the user via the user interface.

### FIELD OF THE INVENTION

This invention relates to a system and method for facilitating the utilization of specialized medical equipment. More particularly, this invention relates to a system for promoting the distribution of medical equipment utilized in minimally invasive medical procedures.

### COPYRIGHT NOTIFICATION

Portions of this patent application contain materials that are subject to copyright protection. The copyright owner has no objection to the facsimile reproduction by anyone of the patent document, or the patent disclosure, as it appears in the Patent and Trademark Office.

### BACKGROUND OF THE INVENTION

U.S. Food and Drug Administration (FDA) approved, minimally invasive or non-invasive medical and surgical procedures offering substantial benefits over conventional methods still face significant market resistance. Surprisingly, the utilization of non-invasive and less invasive medical procedures can be especially constrained by market pressures.

In the United States and many other countries, physicians' fees paid by Medicare and other third-party payers are based on the time, skill and “intensity” (i.e. risk) of a medical or surgical procedure. As a result, physicians are traditionally paid less for performing non-invasive or less invasive procedures than they would receive for performing conventional medical or surgical procedures that require significant skill and time, entail a greater risk to the patient, are significantly more costly and require extensive hospital bed stays and recuperation time. Physicians may not take time away from their practices to learn, or recommend to their patients, less invasive, lower cost procedures, for which they are paid a smaller amount.

For example, an estimated ten million people in the United States suffer from lower back pain, often due to a herniated (bulging) or ruptured lumbar disc. The conventional therapy for a herniated or ruptured lumbar disc is a two hour or longer surgical “discectomy” procedure, which requires general anesthesia and entails a two-to-five day hospital stay, considerable pain for several weeks and a two-to-three month recovery period. In the United States, an orthopedic surgeon is paid approximately $5,000 for performing this procedure.

A less invasive procedure, called endoscopic laser foraminoplasty, to treat herniated or ruptured lumbar discs, is now available in the United States and other countries. The laser and fiber optic needles used to perform this procedure have been cleared for commercial sale in the United States by the FDA. Laser foraminoplasty is a 20 to 30 minute outpatient procedure, performed through an endoscope, which is inserted through a tiny, ¼ inch puncture in the back under local anesthesia. The patient is usually in and out of the hospital in less than two hours with a Band Aid® (Johnson & Johnson, New Brunswick, N.J.) over the puncture (no stitches), and is able to return to normal activities in a few days. In the United States, an orthopedic surgeon is paid approximately $2,800 for performing the laser foraminoplasty procedure, compared to $5,000 for the discectomy surgical procedure.

Published studies show the success rate of the laser foraminoplasty procedure over a period of four years to be 85 to 90 percent, comparable to the success rate of the surgical discectomy procedure, with far fewer adverse effects. If the patient does not know about the laser foraminoplasty procedure and does not ask for, or insist upon the laser foraminoplasty procedure, he is likely to undergo the surgical discectomy procedure.

Alternate medical treatments for angina offer another example. According to a 1998 publication of the American Heart Association, approximately seven million people in the United States suffer from chronic, stable angina (severe chest pain on exertion due to blockages in one or more of their coronary arteries). An estimated 600,000 balloon angioplasties with stents at an average cost of $20,000 (with a 20 percent or greater failure rate), and approximately 450,000 coronary bypass surgeries at an average cost of $40,000 (with a three to eight percent mortality rate, a significant hospital stay and a two to three month recovery period) are performed each year in the United States to treat this condition.

According to published studies, however, approximately 78 percent of chronic, stable angina patients could be successfully treated with a new, outpatient, non-invasive External CounterPulsation (ECP) device that can dramatically increase the circulatory capacity of their hearts by stimulating the growth of new blood vessels in the heart muscle. A recently published study showed the five year survival rate of chronic, stable angina patients after receiving ECP therapy was comparable to the five-year survival rate of chronic, stable angina patients after receiving balloon angioplasty or bypass surgery, based on published studies on these procedures.

No anesthesia is used in the ECP procedure, not even a local anesthetic. The ECP device used in this break-through therapy, which has been cleared for commercial sale in the United States by the FDA, enables the patient to avoid an expensive and risky surgical procedure. The cost to the patient's health plan, insurance company or Medicare is approximately $5,000, which is paid to the hospital or outpatient facility, significantly less than the $40,000 cost of bypass surgery or the $20,000 cost of balloon angioplasty with stents, which are used in approximately 80% of balloon angioplasty procedures.

Traditionally, to treat severe, stable angina, cardiologists perform an angiogram, balloon angioplasty and the implantation of one or more stents in the blocked arteries. These procedures usually require two to three hours of time in an expensive cardiac catheterization facility, entail considerable skill and represent a significant risk to the patient. Cardiologists are paid about $1,500 for performing these procedures on an angina patient in the United States. Hospitals receive the rest of the $20,000 angioplasty/stent cost to third-party players.

If the balloon angioplasty fails, the patient proceeds to coronary bypass surgery, which takes three to four hours and entails significant skill and much greater risk of death or adverse effects. The surgeon's fee for performing bypass surgery in the U.S. is about $2,400, and the hospital receives the balance of the $40,000 fee.

In the United States, Medicare pays a cardiologist $330 for treating a severe angina patient with the outpatient, non-invasive ECP therapy. The physician typically devotes 30 minutes of his time to setting the controls, evaluating the patient's response to ECP therapy, writing the order and reviewing the results after a total of 35 hours of outpatient ECP therapy. A nurse or technician actually treats the patient with the ECP System, one hour per day, five or six days a week over a period of six to seven weeks. With the fee for ECP being only $330, compared to about $1,500 for an angiogram, balloon angioplasty and stents, physicians may not take time away from their practices to learn the new therapy, ask their hospital to buy the equipment or recommend it to their patients. Unless an angina patient knows about ECP therapy and asks for or insists upon ECP therapy, he'll likely get an angiogram, balloon angioplasty, stents and, possibly, coronary bypass surgery, if the angioplasty procedure fails.

There are many other conditions which can be treated less invasively, but physicians may not recommend these procedures to their patients or take time away from their practices to learn how to perform procedures for which they are paid a lower fee. Also, if physicians do not insist that their hospital, outpatient surgery center, clinic or group practice buy the equipment to perform a new procedure, which can cost $100,000 to $400,000, depending on the instruments required, the equipment is usually not purchased.

A variety of other minimally invasive, device dependent procedures suffer the same problems, such as a laser-based procedure to treat enlarged prostates in men, a radio-frequency device to treat gastro-esophageal reflux disease and a cryotherapy-based procedure to treat prostate cancer. All of the above minimally invasive procedures avoid a more invasive surgery, but the physicians's fee is substantially less than for the surgical procedure.

Manufacturers of the equipment and related disposables used in non- and less invasive procedures often do not have the financial resources to advertise the availability of these new procedures nationally. Furthermore, they do not have the means to refer prospective patients to physicians for these therapies, and they do not know what insurance coverages and health plans the physicians will accept. It would be labor intensive and prohibitively expensive for a manufacturer of the medical equipment and disposables used in one, or even several less invasive procedures to enroll hospitals, surgery centers, clinics and physicians as “providers” of the new procedures on a national basis, equip the “providers” with the instruments and disposables needed to perform the new procedures, train the physicians and their staffs to perform the new procedures, collect personal information on the physicians who will perform the new procedures, including what insurance and health plans they will accept, mount a national advertising program to attract persons suffering from a condition that can be treated with one of the new procedures, explain the new procedure and its risks and benefits to persons with such conditions who respond to the advertising program, and arrange appointments for those who want to undergo one of the new procedures with physicians at hospitals or clinics in their vicinity who will accept their insurance or health plan.

Thus, there remains a need for a cost-effective and systematic approach to increasing the demand for and utilization of non-invasive and less invasive medical procedures.

### SUMMARY OF THE INVENTION

Therefore, a computerized method according to the present method facilitates the utilization of a device-dependent medical or surgical procedure for a medical condition and promotes the distribution of the related specialized medical equipment and utilization of disposable devices used therewith. Distribution of the medical equipment is promoted by providing a computer message server that includes a stored, predefined message pertaining to the device-dependent medical procedure and a stored provider directory containing contact information for a plurality of medical service providers qualified to perform the device-dependent medical procedure, including what insurance coverages the medical providers will accept.

A user interface linkage is provided to the computer message server over a wide access communication network for exchanging data with a user, such as a patient interested in a non or less invasive treatment for the specific medical condition, along with information on its risks and benefits, compared to the traditional surgical procedures for treating the condition. An access route to the user interface linkage is advertised publicly, together with an advertised message about the availability of a less invasive or non-invasive procedure to treat the medical condition. The computerized system receives from the user, via the user interface linkage, a user location identifier. The provider directory is queried with the received user location identifier to obtain a result, including contact information for at least one of a plurality of procedure-qualified medical service providers in the vicinity of the user. This result is then communicated to the user.

In a preferred embodiment, the result is a message which includes a list of multiple procedure-qualified medical service providers listed in order, according to proximity to the user based on the user location identifier. The result also preferably includes a disclaimer of liability and a warning message to see a qualified physician for advice specific to his or her medical condition.

In an alternate preferred embodiment, the result is a message which includes a list of multiple procedure-qualified medical service providers listed in order, according to either the provider's proximity to the user based on the user location identifier, or according to whether the provider has paid a monthly fee for a preferred listing position. The result also preferably includes a description of the medical procedure, information on its clinical benefits and a warning message describing the risks associated therewith.

The wide access communication network is preferably a computer network such as the Internet, a telephone network, or a combination of these.

In an alternate preferred embodiment, the computerized system receives from the user both a user location identifier and the user's insurance plan. The insurance plan data is used to selectively display only qualified providers that accept the user's insurance. If none of the medical service providers will accept the user's insurance plan, information may be provided on the medical service providers who perform such procedures on a fee-for-service basis and the insurance coverages and health plans they do accept.

A preferred computer system also allows the user to contact a health plan a preferred provider will accept to enroll therein.

### BRIEF DESCRIPTION OF THE DRAWINGS

In the accompanying drawings that form part of the specification,

FIG. 1 is a schematic block diagram illustrating the software modules and computer hardware of an Internet-connected system for the promotion of less invasive medical or surgical procedures or other predetermined types of procedures; FIG. 2 is a simplified flowchart of a preferred Internet-based embodiment of method steps according to the present invention for promotion of predetermined medical or surgical procedures;

FIG. 3 is a schematic block diagram illustrating the software modules, computer hardware and connections of a telephone interactive messaging system for the promotion of a non-invasive medical or surgical procedure for the treatment of angina in accordance with an alternate embodiment of the present invention;

FIG. 4 is a simplified flowchart of a preferred telephone-based embodiment of method steps according to the present invention for promotion of a non-invasive medical procedure for the treatment of angina;

FIG. 5 is an exemplary advertisement message directing prospective users to an Internet World Wide Web site (e.g. 123emed.com) and a toll-free phone message service for information about therapies for angina in accordance with an embodiment of the present invention;

FIG. 6 is an exemplary advertisement message directing prospective users to an Internet World Wide Web site and a toll-free phone message service for information about therapies for a herniated or ruptured lumbar disc in accordance with an embodiment of the present invention;

FIG. 7 is an introductory Internet World Wide Web site display allowing users accessing a website (e.g. 123emed.com) to select from a menu of medical conditions in accordance with an embodiment of the present invention; and

FIG. 8 is a flowchart representing the commercial application of an embodiment of the present invention.

In the FIGURES, a single block or cell may indicate several individual software and/or hardware components that collectively perform the identified single function. Likewise, a single line may represent several individual signals or several instances of software data sharing or interconnection.

### DESCRIPTION OF THE PREFERRED EMBODIMENTS

The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

The present invention provides a system and method for promoting and facilitating the utilization of device-dependent medical treatments or surgical procedures for a medical condition by attracting and efficiently referring targeted consumers to medical service providers owning the necessary equipment and qualified to perform the procedures. The present invention is especially advantageous for the promotion of less invasive and non-invasive medical procedures.

As used herein, the terms [symbol] medical procedure [symbol] and [symbol] medical treatment [symbol] and grammatical variations thereof, are used interchangeably to refer to surgical and non-surgical procedures, treatments, therapies, tests, regimens and the like. The term [symbol] less invasive, [symbol] as used herein, is reference to procedures which can be labeled less invasive, minimally invasive and not or non-invasive.

A system aspect of the present invention includes a computer message server that includes a stored, predefined message pertaining to selected medical conditions, information on alternate therapies, including the device-dependent medical or surgical procedure and a stored provider directory containing contact information for a plurality of medical service providers qualified to perform the device-dependent medical procedure. The message server is Internet-linked and equipped with display-generating Hypertext Markup Language (HTML) files. An access route to the user interface linkage is advertised publicly together with an ad message about the medical condition and alternate therapies.

The computerized system receives from the user via the Internet a user location identifier such as a ZIP code or telephone area code. Implemented with database application software, the provider directory can be queried with the user ZIP or area code. Displayed to the user over the Internet, the query result includes information on alternate therapies for the medical condition, including the less invasive or non-invasive procedure, and contact information for the nearest qualified service providers.

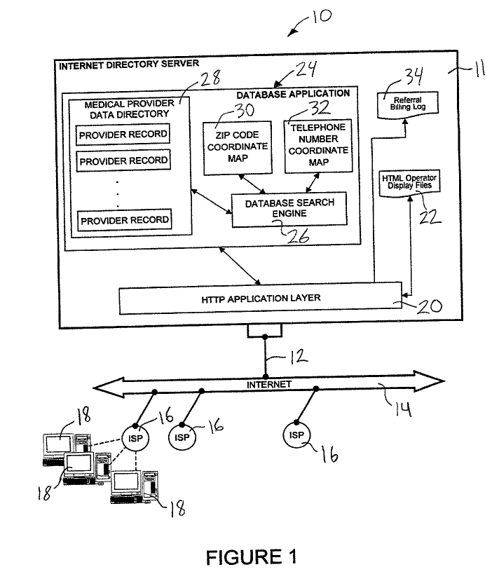

Referring now to FIG. 1 for a more detailed description, the elements of a Internet-based provider directory server system 10 are shown. System 10 is preferably implemented on a general purpose computer 11 with sufficient hardware and software resources to act as an Internet World Wide Web server. The phrase “general purpose computer,” as used herein, is a reference to commercially standard computers which are designed for multiple applications as opposed to CPU-based electronics customized for a specific application such as device control. Examples include the well-known group of computers conventionally labeled IBM-compatible personal computers, or more simply PCs. PCs are based on complex instruction set (CISC) CPUs from Intel Corporation (INTEL), Advanced Micro Devices, Inc. (AMD), VIA Technologies, Inc. and others. The related, evolving CPU product line from INTEL includes CPU chipsets available under designations such as “80486®,” “Pentium®,” “Pentium® II,” “Pentium® III.” An exemplary CPU product line for general purpose computers by AMD is available under the designation “AMD-K6®.” VIA Technologies, Inc. CPUs for general purpose computers are sold under the designation “Cyrix®.”

General purpose computers based on reduced instruction set (RISC) CPUs are also well known. Examples include computers based on the Alpha® chipset available from the Compaq Computer Corporation.

Also suitable are the computers commercially available from Silicon Graphics, Inc. (Mountain View, Calif.) under the designation “Origin 200.”

Computer 11 preferably operates with a general purpose networkable operating system. The phrase “general purpose networkable operating system” is a reference to commercially standard operating systems such as those available from the Microsoft Corp. under designations such as Windows® NT and Windows 2000®. Other examples of general purpose operating systems include Macintosh® (Apple Computers, Inc.), UNIX (various resellers) and Open VMS® (Compaq Computer Corporation).

System 10, which could also be labeled a computer message server, is operably linked by a combination hardware-software connection (or linkage) 12 to a wide access communication network in the form of the Internet 14. The Internet 14 includes a plurality of on-line service providers 16 from which individual users gain access via computer terminals 18 from homes, offices, wireless telephones and libraries, etc.

While the Internet is preferred as the most widely available data access network, the present invention necessarily applies to a variety of wide access data networks. Suitable data networks include the subscription network services such AOL® from America Online, Inc. (Dulles, Va.) and CompuServe® from Compuserve Interactive Services, Inc. (Columbus, Ohio), company intranets, and national data network utilities such as France's Minitel.

Installed for running on the general purpose computer 11 are a network application HTTP layer module 20, HTML operator display files 22, and a database application module 24. The term “module,” as used herein is a reference to a software element such as a program, subprogram, software process, subroutine, or grouping of code segments and the like. The software modules of system 10 are preferably discrete executable programs which run as discrete processes. Unless otherwise indicated, the software modules and code segments are configured to share access to a variety of software variables and constants as needed through subroutine calls, common shared memory space, and the like.

HTTP layer 20 represents the software necessary for Internet communication protocols such as the low level TCP/IP and the application level World Wide Web (“the Web”/HTTP/HTML). HTML files 22 represent the hierarchy of stored HTML files for creating user displays which appear on an Internet user's computer when accessing the provider directory system 10. While HTML is preferred, the provider directory system 10 could also be implemented using VRML or any other suitable language which allows for user display creation over the World Wide Web layer of the Internet.

The stored HTML files 22 include displays with predefined messages about the medical procedure targeted for promotion. Also preferably stored among the HTML files 22 are displays describing the medical condition which the medical device is designed to treat or diagnose. Table I, below, includes a list of HTML displays for exchanging information with a user over the Internet.

TABLE I
HTML User Interface Display Files

Introductory Display With Messages and
Switches Enabling a User to Obtain
Information Concerning a Selected Medical
Condition, Including a Switch for Requesting
Additional Information
Display With Message Containing Information
About Conventional Medical or Surgical
Procedures and the Less Invasive or Non-
Invasive Medical Procedure for the Identified
Medical Condition
Display Requesting User ZIP or Telephone Area
Code
Display Requesting Reentry of ZIP or Area
Code
Display Requesting User's Insurance Company
and Health Plan
Display Enabling User to Request a List of
Qualified Providers in His/Her Locality
Display for Presenting a List of Qualified
Medical Service Providers With Links on Each
Medical Provider for Gaining Further Detail
Display for Presenting Complete Contact
Information for a Selected Provider
Display Presenting Disclaimer and Warning
Display for Requesting an Appointment With a
Selected Provider

A suitable software program for development and maintenance of user-accessible Internet Web-site files and hierarchy is available from 4D, Inc. (San Jose, Calif.) under the designation “4D Version 6.0.”

General purpose computer 11 is also setup to run a general-purpose database application module 24 that has been customized and configured to provide aspects of the provider referral service. Database application 24 includes a search engine module 26 for querying data files and a medical provider directory 28, a ZIP code coordinate map 30 and an optional but preferred telephone number coordinate map 32.

A variety of database development programs with query functions are available for creating and maintaining the data directories. These include Oracle, Sybase SQL, Powersoft, and Microsoft Access, with Oracle being preferred.

Medical provider directory database 28 is populated with contact information for medical service providers who have access to necessary equipment and are qualified to perform the procedure to be promoted. Table II, below, describes the field configuration for records in the provider directory 28.

TABLE II
Medical Provider Data Directory Record

| Field Designation | Data Format |
|---|---|
| PROVIDER NAME | TEXT |
| PROVIDER TYPE | ENUMERATION |
| (HOSPITAL, MED. CENTER, GROUP | |
| PRACTICE, INDIV. PHYSICIAN) | |
| AFFILIATES (PHYSICIANS OR | TEXT (MULTI) |
| FACILITIES) | |
| SUBSCRIPTION CLASS | ENUMERATION |
| (SUBSCRIBER, QUALIFIED | |
| AFFILIATE, QUALIFIED) | |
| STREET 1 | TEXT |
| STREET 2 | TEXT |
| CITY | TEXT |
| STATE | TEXT |
| ZIP CODE | INTEGER |
| LATITUDE COORDINATE | FLOATING POINT |
| LONGITUDE COORDINATE | FLOATING POINT |
| HEALTH PLANS ACCEPTED | TEXT (MULTI) |
| TELEPHONE | TEXT |
| E-MAIL ADDRESS | TEXT |
| FACSIMILE | TEXT |

The PROVIDER TYPE field allows provider system 10 to separately track individual physicians, physician groups, outpatient surgery centers, hospitals and medical centers. The AFFILIATES field allows system 10 to relate individual physicians to physician groups, outpatient surgery centers, hospitals and medical centers. Together the PROVIDER TYPE and AFFILIATES field allows system 10 to provide users with lists of individual physicians associated with a qualified physician group, outpatient surgery center, hospital or medical center.

Data about a provider's relationship to the referral service is recorded in the SUBSCRIPTION CLASS field. In the preferred approach to the present invention, individual physicians, physician groups, outpatient surgery centers, hospitals and medical centers may subscribe to the promotion service. The SUBSCRIPTION CLASS field allows system 10 to make patient referrals for any medical service provider qualified to perform the procedure to be promoted, but to give subscribing providers preferential treatment such as preferential listing in a given area. Therefore, the SUBSCRIPTION CLASS field also allows for an evolution of the promotion service. In the early stages of a promotion effort, the promotion goal is best served by having as many qualified providers as possible making system 10 worthwhile for users. In later stages, when a large group of providers is established, the promotion service can more effectively require that providers subscribe and pay fees in order to be given a preferential listing position.

In addition to address, telephone and e-mail address fields, the records of provider directory 28 include fields for LATITUDE COORDINATE and LONGITUDE COORDINATE. The latitude and longitude data allows for more efficient proximity-based comparisons.

As noted above, the Internet based display screens call for a user of system 10 to enter a ZIP Code or telephone area code number. The databases designated ZIP code coordinate map 30 and telephone number coordinate map 32 relate latitude and longitude coordinates to postal ZIP codes or telephone area code numbers, respectively. The combination of the LATITUDE COORDINATE and LONGITUDE COORDINATE fields of provider directory 28 and the ZIP code map 30 or area code number map 32 allow efficient proximity calculations and querying.

Such coordinate mapping data files are commercially available and include latitude and longitude data associated with ZIP codes and telephone area codes (NPA) and central office code (NNX). While on-server coordinate map databases are preferred for reliability and speed, such data can be obtained over the Internet as needed from specialized subscription services, such as data provided by Switchboard, Inc. (Westboro, Mass.).

The HEALTH PLAN ACCEPTED field tracks the health plans accepted by the provider and allows system 10 to list medical service providers according to whether a user's health plan is accepted.

System 10 also includes referral billing log 34 and associated code segments for recording each user access and provider referral. As contemplated, the promotional service is funded by charging either a percentage of the equipment sales price, a fixed [symbol] per case [symbol] fee or a periodic subscription fee to the related equipment manufacturer and a fixed or periodic subscription fee to the listed medical service providers qualified to perform the target procedure. According to a preferred approach to the present invention, equipment manufacturers are charged a fee based on the sales price of the equipment and supplies used in the target procedure, and listed medical service providers are charged a monthly fee based on a mark-up over the cost of the advertising and/or the number of users asking to be referred to their offices. Referral tracking and logging provides a data set valuable for marketing the promotion and referral service. Table III, below, is a list of the data field formats for the referral billing log record.

TABLE III
Referral Billing Log Record

| Field Designation | Data Format |
|---|---|
| PROVIDER REFERRED | TEXT |
| REFERRAL DATE | DATE |
| REFERRAL TIME | TEXT |
| REFERRAL PLACEMENT | INTEGER |
| FULL CONTACT VIEWED | BINARY |
| USER LOCATION IDENTIFIER | INTEGER |

The REFERRAL PLACEMENT field allows system 10 to log whether the provider was placed at the start of a list viewed by the user. Likewise, the FULL CONTACT VIEWED field allows system 10 to log whether a user chose to view complete contact data for the identified provider.

Flowchart FIG. 2 presents a method embodiment of the present invention for promoting the utilization of a selected medical or surgical procedure. At box 37, a user accesses an advertised website, such as www.123emed.com. HTML files resident on a server system such as system 10 are loaded on the user's computer to generate a display. First, an introductory display presents a list of medical conditions for which a non- or less invasive procedure is being promoted (box 38). At box 39, system 10 checks if the medical condition Angina has been selected. Box 40 represents the steps of checking for a user's selection of other medical conditions with corresponding HTML displays.

If the user has clicked on (or otherwise selected) “angina” from the listing to learn information about therapy options for angina, a display is provided with information about angina and related therapies, new and conventional (box 41). Next, the user is offered an option to continue and receive more information (box 42). Box 44 represents the step of checking on the user's decision whether or not to get additional information.

Box 46 represents the user's decision not to proceed. If the user decides to proceed, system 10 presents a display allowing the user to request a list of qualified providers in his locality by inputting a user location identifier, such as a ZIP code or telephone area code (box 48). The ZIP code (or other location) data is checked for valid format (box 50). At box 52, system 10 obtains user location coordinates, for example, based on the user ZIP code from ZIP code coordinate map 30.

Information about this user inquiry is stored for billing purposes (box 54).

The user is then asked to enter his/her insurance company and health plan or select from a list of carriers and their health plan (PPO, HMO, indemnity, etc.)(box 56). For example, system 10 presents the user with a menu display for selecting from a plurality of health insurance plans (.e.g., insurance companies, HMOs, Medicare, Medicare supplement plans, etc.).

Box 58 confirms if a health plan was selected by the user. If the user fails to select a health plan, the display ends (box 59). For users having entered or selected valid health insurance information (box 58), system 10 searches provider data directory 28 based on the user location coordinates to obtain a list of qualified providers within a predetermined distance, e.g. up to 100 miles, from the user (box 60). The preferred predetermined distance necessarily varies according to the medical procedure being promoted. A user display with a menu for selecting a proximity limit is also contemplated.

The obtained list of providers may be queried and arranged in an order giving preference to providers accepting the user's health insurance plan as indicated at box 62. Next, the Internet-enabled user is presented with a display listing qualified providers (box 64). At box 66 is represented the step of recording this referral in referral billing log 34.

Also contemplated is a feature which allows users to select a specific service provider from the listing of qualified providers, and request from that specific provider, an appointment. Appointment times are preferably set on-line by using a provider appointment schedule maintained by system 10. Alternatively, the appointment request may be electronically forwarded (e.g. e-mail, facsimile) to the service provider with user contact information thereby allowing a representative of the provider to directly contact the interested user. Alternatively, the selected provider's telephone number can be displayed.

While an Internet-based embodiment of the present invention offers advantages in flexibility for presenting information to a user, a telephone network-based embodiment is advantageous in that the public telephone network has an even wider distribution among consumers. Moreover, users unfamiliar with using a computer terminal are generally comfortable using telephone messaging systems.

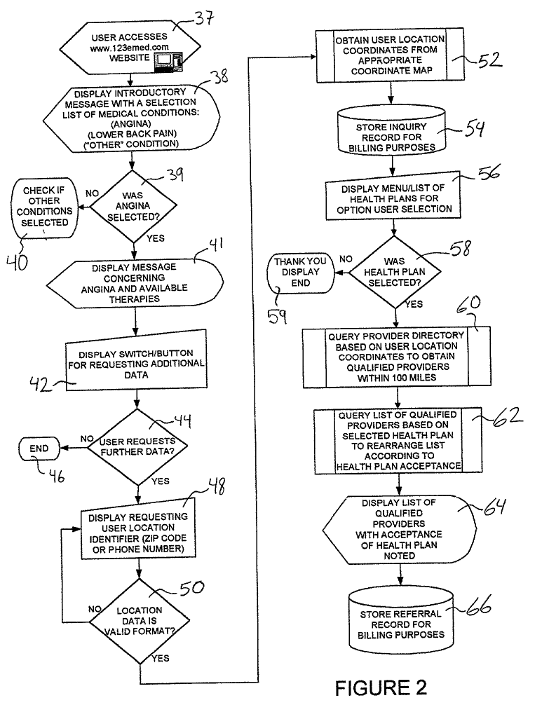

Accordingly, the present invention includes a system and method for promoting the utilization of a selected medical procedure via the telephone network. Referring now to FIG. 3 for a more detailed description, the elements of a telephone-based promotional system 110 are shown. System 110 is preferably implemented on an interactive voice response unit (IVRU) computer 111. IVRU computer 111 is operably linked by a conventional trunk connection 112 to a wide access communication network in the form of the public telephone network 114. As illustrated, a series of phone lines 116 from which individual users connect to IVRU computer 111 are provided by a telephone company as a trunk line 112.

Running on the IVRU computer 111 are a script execution module 170, a script of audio input/output digital audio files 122, and a database application module 124. Script execution module 170 oversees the execution of a script program such as 122, which dictates the order of playing selected audio files (e.g. 178), the input requests, and required database queries via database application 124.

Script execution module 170 includes a DTMF decoder 172 and a text-to-audio voice converter 174. DTMF decoder 172 is provided to convert telephone touch-tone entries by the user into computer data. Text-to-audio voice converter 174 is provided to convert computer based contact information into an audio voice message. Script execution module 170 optionally but preferably includes a voice recognition decoder 176 for converting simple spoken words by the user into computer data.

Angina script 122 includes predefined audio messages about conventional therapies and the less invasive or non-invasive medical procedure targeted to be promoted. Specifically, system 111 includes at least an angina introduction message 178, an angina data request message 180, and a treatment warning message 182. Additional message files 183 may be stored and played as desired.

IVRU computer 111 includes a general-purpose database application module 124 customized and configured to provide aspects of the provider referral service as described above for Internet-based system 10 and computer 11. Database application 124 includes a search engine module 126 for querying data files, a medical provider directory 128, a ZIP code coordinate map 130 and an optional, but preferred, telephone area code number coordinate map 132.

As discussed above for directory 28, medical provider directory database 128 is populated with contact information for medical service providers who have access to necessary equipment and are qualified to perform the procedure to be promoted. Table I, above, describes the field configuration for records in the provider directory 128. In an alternate embodiment, the records of directory 128 may include both contact data and corresponding digital audio recordings thereby eliminating the need for text-to-audio voice converter 174.

Like system 10, telephone-based promotional system 110 also includes a referral billing log 134 and associated code segments for recording each user access and provider referral. The referral billing log 134 allows for a variety of subscriber billing options.

Telephone-based promotional system 110 is preferably composed of hardware and software components specially created for the telephone messaging application. Such system components are commercially available from AT&T, Inc. under the designation “AT&T 6486/6386 StarStation” and “VRU AT&T Voice Power IV (VP4).” Less costly systems can be created by equipping a general purpose computer with hardware peripherals and a related interface for system connection. For example, PC-compatible telephony equipment is commercially available from the Dialogic Corporation (Parsipanny, N.J.) under the commercial designation “SingleSpan™ Series.”

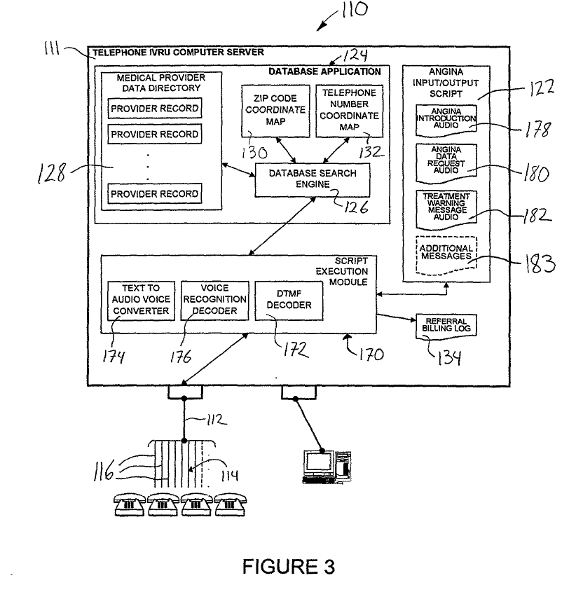

Flowchart FIG. 4 describes a method embodiment of the present invention for promoting the utilization of a selected less invasive or non-invasive medical or surgical procedure over a telephone network. At box 230, a telephone user dials an advertised toll-free number such as 1-800-NNN-NNNN to learn information about therapy options for the advertised medical conditions. Telephone message server 110 answers the call and a medical condition menu message is played (box 232) which enables users to select from a list of advertised conditions by pressing a telephone keypad button. Box 234 represents the step of system 110 checking and waiting for a telephone keypad entry.

While flowchart FIG. 4 calls for touch-tone phone entries, a system and method according to the present invention may also rely on conventional voice recognition or combinations of voice recognition and touch-tone entries.

If the user presses keypad button “1” for angina (box 236), system 110 triggers script execution module 170 to run angina input/output script 122 and an introductory message 178 is played to the caller with information about angina and related therapies, new and conventional (box 240). Flowchart box 238 represents the steps of checking for and processing a user's selection of a different medical condition, such as lower back pain.

After the introductory message, the user is offered an option to continue and receive more information (box 240). If the user requests more information (box 244) by touching a phone key as detected by DTMF decoder 172, an audio message introducing ECP is played as represented by flow chart box 246.

At box 248, a message 180 is played asking the user if he wants to hear about qualified providers in his locality by entering a user location identifier such as a ZIP or telephone area code. As dictated by script program 122, user entries are checked for valid ZIP or area code format (box 250). An invalid format triggers a reentry message as represented by box 251. After a valid ZIP or area code has been entered, system 110 plays a warning message 182 (box 252).

In the process step represented by box 254, system 110 uses database application 124 to obtain user location coordinates based on the user ZIP or area code from ZIP or area code coordinate map 130. Given user coordinates, provider data directory 128 is searched based on the user location coordinates to obtain a list of a predetermined maximum number of qualified providers within a predetermined distance, e.g. up to 50 miles, from the user (box 256). A list of up to five providers is preferred.

The communication of results to the user then proceeds one-provider at a time with user prompting. At box 258, a message introducing a provider is played. Box 260 represents the on-demand conversion from text to audio of a providers contact information using converter module 174. The provider contact information played to the user preferably includes the name, phone number and street address.

For each playing of contact information to a user, a provider referral record is stored for billing purposes (box 262). The telephone user is offered the option of repeating contact information for the last provider (box 264) or moving on to the next nearest provider as represented by boxes 265, 267, 269 and 270.

More specifically, the step of checking for a phone keypad entry within a predetermined amount of time is represented by box 265. If no entry is made after a predetermined amount of time passes, system 110 proceeds to box 269 to check if information on another provider can be played to the user. At box 267, system 110 checks for a phone keypad entry of “1,” indicating the user's choice to repeat provider information. If a phone keypad entry of “1” is detected, the process flow returns to box 260 and the provider information is repeated. If a phone keypad entry other than “1,” e.g. “2,” is detected, system 110 proceeds to box 269.

Box 269 represents the process step of checking if contact information has been played for all the identified qualified providers. If there are more qualified providers to list to the user, system 110 increments a counter variable (box 270) and plays contact information for the next provider to the user.

When system 110 has played contact information for the last provider, the user may be offered a telephone connection to a provider, selected by the user by touching a key, for an additional charge (billed to the user's telephone). If no specific provider is selected, a courtesy message is played before disconnecting the telephone user (box 272).

In an alternate embodiment of the present invention, telephone-based promotional system 110 is equipped with a software module for automatically detecting a caller's phone number using the Automated Number Identification (ANI) system, a service available from the phone company providing a toll-free number. By retrieving the user's phone number automatically upon dialing, the step of requesting a user location identifier such as a ZIP code or phone number can be eliminated.

With regard to a telephone network-based approach to the present invention, the use of live human telephone operators equipped with computer terminals linked to system 10 (FIG. 1) is also contemplated. According to this live operator approach to the present invention, users would place a telephone call and reach a live telephone operator. The telephone operator would read to the user the display messages generated by system 10, including warning messages (i.e. a script), and input to system 10 data received verbally from the user. The resulting list of service providers is also read by a live operator to the user via telephone.

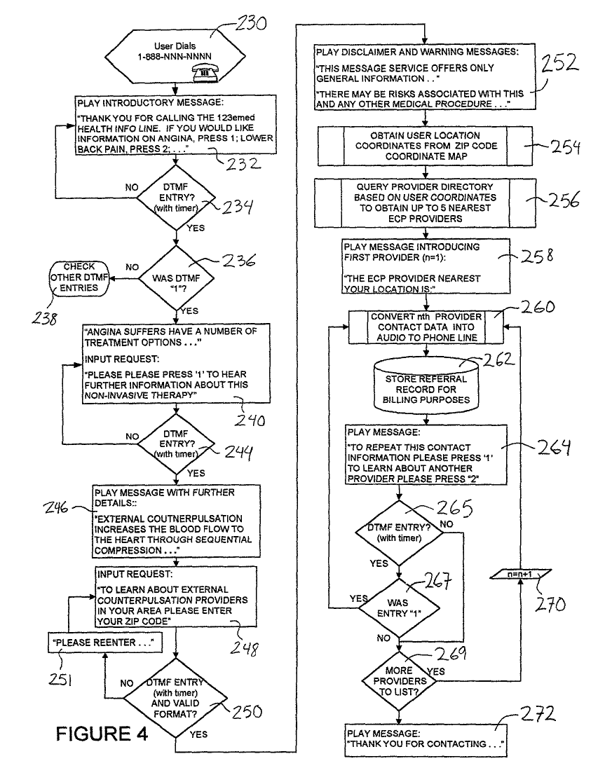

The method aspects of the present invention include the step of publicly advertising the information service. FIG. 5 is an advertisement message 300 for attracting users interested in a treatment for angina, directing them to an Internet World Wide Web site 302 (www.123emed.com) or a toll free number 304. A variety of print media, poster, radio, television and Internet advertising are contemplated for directing consumers to Internet and/or phone message provider directories equipped as described above.

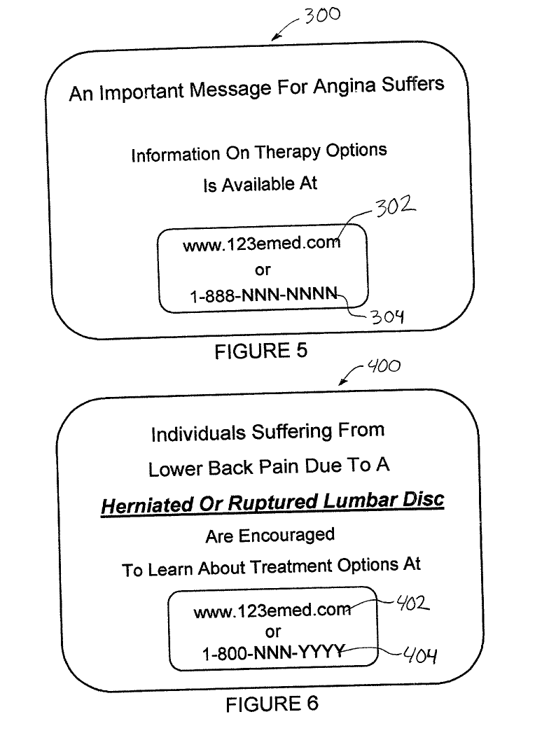

FIG. 6 is a screen print of an introductory advertisement page 400 for attracting users interested in a treatment for back pain. Introductory page 400 directs users for information on treatment options to the 123emed Web site 402 or 123emed's toll free telephone number 404.

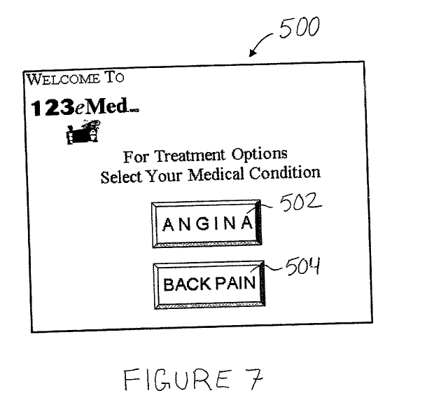

As seen in FIG. 7, when a user accesses the 123emed.com website page 500, the user is offered the opportunity to select by HTML link buttons for information on treatment options for one of a variety of selected medical conditions, such as angina 502 or back pain 504.

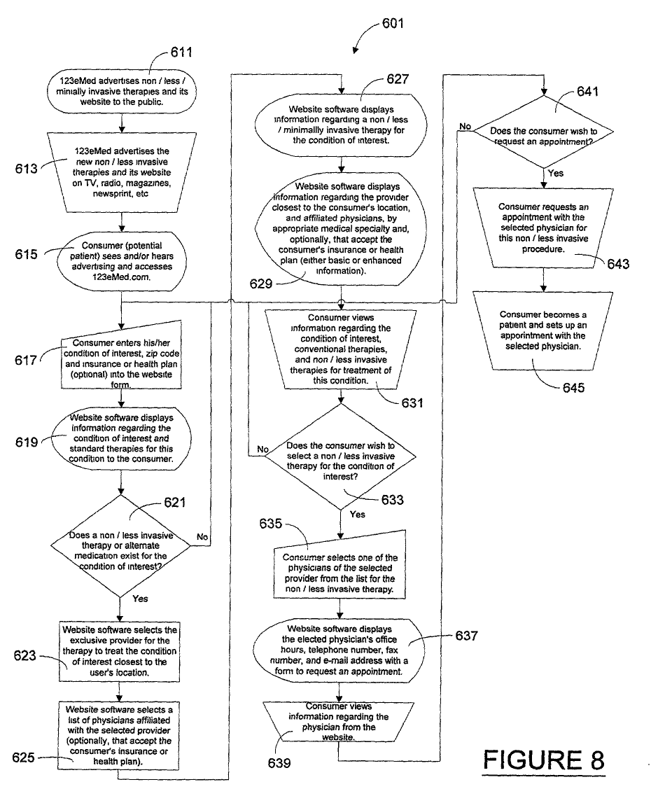

The present invention is especially suited for the commercial promotion of less invasive and non-invasive medical and surgical procedures and related medical equipment sales as illustrated in flowchart 601 of FIG. 8. Flowchart boxes 611 and 613 represent the step of advertising minimally invasive therapies generally and by specific media to consumers (i.e. users) together with contact information for reaching internet server system 10 (FIG. 1) and/or telephone system 110 (FIG. 3).

In response to the advertising, a user accesses 123emed.com as represented by box 615. At 123emed.com, the user selects (or enters) the medical condition of interest and then enters zip code and health insurance coverage information (box 617). Given the user's information, system 10 displays to the user information regarding the condition of interest and standard therapies for this condition (box 619).

Box 621 represents the computerized step of determining whether a less or non-invasive therapy exists for the user identified medical condition. If a less or non-invasive procedure is available, system 10 preferably first identifies a procedure-qualified provider facility in the form of an office for a physician group, an individual physician's office, a clinic, an outpatient surgery center, a hospital or a medical center (box 623). System 10 then also selects a list of physicians affiliated with the selected provider facility (box 625).

Flowchart box 627 represents the step of displaying to the user via the Internet website display pages information to the user about a less invasive therapy for the condition of interest. Following the display of background information on the less invasive procedure, system 10 displays information regarding provider facilities and physicians qualified to perform the less invasive procedure which are nearby the user (box 629). As box 629 indicates, the user's health plan may control which providers are displayed.

System 10 allows the user to view additional information (box 631) and to choose to select a less or non-invasive therapy (box 633). Next, the user selects one of the physicians (or providers) as represented by flowchart box 635. Triggered by the user's selection, system 10 then displays the target physician and/or provider contact information (box 637). Also represented by box 637 is system 10's presentation of a fill-in-the-blanks Internet based form for requesting an appointment with the selected physician.

After viewing additional information on the provider (box 639), using the appointment request form (box 637), the user has the option (box 641) to request an appointment (box 643) and becomes a patient (box 645), or the user may return to the zip code entry step (box 617).

Numerous variations and modifications of the embodiments described above may be effected without departing from the spirit and scope of the novel features of the invention. It is to be understood that no limitations with respect to the specific methods or systems illustrated herein are intended or should be inferred. It is, of course, intended to cover by the appended claims all such modifications as fall within the scope of the claims.

I claim:

1. A computerized method for facilitating the utilization of a device-dependent medical procedure for a medical condition, the method comprising:
providing a computer message server including a stored, predefined message pertaining to said medical procedure and a stored provider directory of a plurality of procedure-qualified medical service providers;
providing a user interface linkage to said computer message server over a wide access communication network for exchanging data with a user;
advertising publicly an access route to said user interface linkage together with an ad message about said medical condition;
receiving from said user via said user interface linkage a user location identifier;
querying said provider directory with said user location identifier and obtaining a result, said result including contact information for at least one of said plurality of procedure-qualified medical service providers; and
communicating said result to said user via said user interface linkage.

2. The method of claim 1 wherein said result is a result message including a list of procedure-qualified medical service providers in an order according to proximity to said user based on said user location identifier.

3. The method according to claim 1 wherein said computer message server is an Internet server.

4. The method according to claim 1 wherein said computer message server is an Internet server including HTML files for generating user displays, wherein said stored, predefined messages are files including text, and wherein said user interface linkage is an operable connection between said Internet server and said Internet.

5. The method according to claim 1 wherein said computer message server is a telephone message server, wherein said stored, predefined messages are audio message files and said user interface linkage is an operable connection between said telephone message server and a public telephone switching network.

6. The method of claim 1 further comprising charging a subscription fee to a medical service provider for including said medical service provider in said provider directory.

7. The method of claim 1 further comprising maintaining a referral database by recording each said location and each said result obtained therefrom.

8. The method of claim 1 further comprising charging a per referral fee to a medical service provider included in said provider directory when said result includes said medical service provider.

9. The method of claim 1 further comprising charging a per inquiry fee to a medical device seller of said medical device for each said result communicated to said user.

10. The method of claim 1 further comprising charging a commission fee to a medical device seller of said medical device for each sale of said medical device.

11. The method of claim 1 further comprising receiving from said user via said user interface linkage a user health insurance plan and wherein said provider directory includes data associating said plurality of procedure-qualified medical service providers to accepted health insurance plans.

12. The method of claim 1 wherein said user location identifier is a telephone area code or a unique telephone number.

13. The method of claim 1 wherein said user location identifier is a user ZIP code.

14. A computerized method for facilitating the utilization of a medical device for a device-dependent procedure suitable for treating a medical condition, the method comprising:
maintaining a computerized data directory of a plurality of procedure-qualified medical service providers;
providing a user interface to said data directory through a wide access communication network for exchanging data with a user;
receiving from said user via said user interface an inquiry pertaining to a medical condition;
querying said data directory with said inquiry and obtaining a result; and
communicating said result to said user via said user interface.

15. The method of claim 14 further comprising receiving from said user via said user interface a user health insurance plan and wherein said provider directory includes data associating said plurality of procedure-qualified medical service providers to accepted health insurance plans.

16. The method of claim 14 wherein said inquiry includes a medical condition of concern to said user and said result includes a message identifying a device-dependent medical procedure for said medical condition of concern.

17. The method of claim 16 wherein said message further includes the identification of a procedure-qualified medical service provider for said device-dependent medical procedure.

18. The method of claim 16 wherein said message further includes contact information for a plurality of procedure-qualified medical service providers for said device-dependent medical procedure.

19. The method of claim 16 wherein said inquiry includes a user location identifier for preferentially selecting procedure-qualified service providers with locations near said user.

20. The method of claim 19 wherein said user location identifier is a user telephone area code number or a unique telephone number.

21. The method of claim 19 wherein said user location identifier is a user ZIP code.

22. The method of claim 14 further comprising charging a subscription fee to a medical service provider for including said medical service provider in said data directory.

23. The method of claim 14 further comprising maintaining a referral database by recording each said inquiry and each said result.

24. The method of claim 14 further comprising charging a per referral fee to a medical service provider included in said data directory when said result includes said medical service provider.

25. The method of claim 14 further comprising charging a per inquiry fee to a medical device seller of said medical device for each said result communicated to said user.

26. The method of claim 14 further comprising charging a commission fee to a medical device seller of said medical device for each sale of said medical device.

27. The method of claim 14 wherein said plurality of medical service providers includes a physician.

28. The method of claim 14 wherein said plurality of medical service providers includes a hospital.

29. The method of claim 14 wherein said plurality of medical service providers includes an outpatient surgery center.

30. The method of claim 14 wherein said wide access communication network is the Internet.

31. The method of claim 14 wherein said wide access communication network is a public telephone switching network.

32. The method of claim 14 wherein the step of providing a user interface to said data directory through a wide access communication network includes simultaneously providing an operable link between said data directory and both the Internet and a public telephone switching network.

33. A computerized method for facilitating the utilization of a less invasive medical procedure for treating a medical condition, the method comprising:
maintaining a computerized data directory of a plurality of medical service providers qualified to perform said medical procedure;
providing a user interface to said data directory through a wide access communication network for exchanging data with a user;
receiving from said user via said user interface an inquiry pertaining to medical procedures for a medical concern, said inquiry including a user location identifier;
querying said data directory with said inquiry and obtaining a result; and
communicating said result to said user via said user interface.

34. The method according to claim 33 further including publicly advertising an access route to said user interface and said medical condition.

35. The method according to claim 33 wherein said data directory is resident on a call-server computer and said access route is a telephone number.

36. The method according to claim 33 wherein said data directory is resident on an Internet server computer and said access route is an Internet website domain name.

37. The method according to claim 33 wherein said data directory is resident on an Internet server computer and said access route is an Internet e-mail address.

38. A computerized method for facilitating the utilization of a plurality of different medical devices utilized in device-dependent medical treatments for a plurality of different medical conditions, the method comprising:
maintaining a provider database including a conditions directory of different medical conditions for which a device-dependent treatment is available utilizing a medical device and a provider directory of device-qualified medical providers for each said device-dependent treatment;
providing a user interface to said provider database through a wide access communication network for exchanging data with a user;
receiving from said user an inquiry pertaining to treatment options for a medical condition;
querying said provider database with said received inquiry and obtaining a result; and
communicating said result to said user via said user interface.

39. The method of claim 38 wherein said inquiry includes a medical condition of concern to said user and said result includes a message identifying a device-dependent medical treatment for said medical condition of concern.

40. The method of claim 38 wherein said message further includes the identification of a device-qualified medical service provider for said device-dependent medical treatment.

41. The method of claim 38 wherein said inquiry includes a medical condition of concern to said user and said result includes a message that no provider of the device-dependent medical treatment in the user's locality or accepting the users health plan could be identified.

42. The method of claim 38 further comprising receiving from said user via said user interface a user health insurance plan and wherein said provider directory includes data associating said plurality of procedure-qualified medical service providers to accepted health insurance plans.

43. The method of claim 38 further comprising charging a per referral fee to said qualified medical service providers included in said provider directory when said result includes said medical service provider.

44. The method of claim 38 further comprising charging a per inquiry fee to a medical device seller of said medical device for each said result communicated to said user.

45. The method of claim 38 wherein said receiving from said user via said user interface an inquiry pertaining to a medical condition includes the steps of:
responding to an access to said user interface with a menu of medical conditions; and
receiving from said user via said user interface a selection from said menu.

46. A computerized method for facilitating the utilization of a medical procedure requiring a specialized medical device, the method comprising:
providing a computerized data directory of a plurality of medical service providers equipped with said specialized medical device and qualified to perform said device-dependent medical procedure;
providing a user interface to said data directory through a wide access communication network for exchanging data with a user;
receiving from said user via said user interface an inquiry pertaining to medical procedures for a medical concern and a user location identifier;
querying said data directory with said inquiry and obtaining a result; and
communicating said result to said user via said user interface.
